(19) United States
(12) Patent Application Publication
(10) Pub. No.: US 2024/0377177 A1
(43) Pub. Date: Nov. 14, 2024

(54) MEASUREMENT TOOL WITH KEYED FINGERS

(71) Applicant: Volvo Car Corporation, Göteborg (SE)

(72) Inventors: David Joiner, Göteborg (SE); Thomas Johnson, Göteborg (SE)

(21) Appl. No.: 18/195,500

(22) Filed: May 10, 2023

(51) Int. Cl. G01B 3/34

(52) U.S. Cl. CPC G01B 3/34; G01B 5/14

(57) ABSTRACT

A measurement tool with keyed gauges or fingers that mitigates process reliability concerns. A holder or disc is used for a task or tasks associated with a given shop or process that utilizes gauges or fingers that are keyed and also color-coded, labeled, or otherwise differentiated such that only the proper gauges or fingers among similar gauges or fingers can actually be received in that holder or disc for that shop or process. Accordingly, if a user has the correct holder or disc for a shop or process, only the proper gauges or fingers can be used. For each shop or process, measurement process instructions or steps can also be provided for each task associated with a holder or disc and the associated keyed gauges or fingers by color-coding, labeling, or differentiation correspondence.

### TECHNICAL FIELD

The present disclosure relates generally to the automotive field. More particularly, the present disclosure relates to a measurement tool with keyed fingers. Further, the present disclosure relates to a method for managing measurement processes using the measurement tool.

### BACKGROUND

In an automotive (or other) manufacturing facility/process, team members may move from shop to shop or process to process and have to familiarize themselves with different measurement tools, such as go-no go (GNG) tools for measuring seam width and depth tolerances and the like. In different shops and processes, multiple min/max gauges or fingers may be used to perform a series of measurement tasks. These gauges or fingers are often coupled to a holder or disc and color-coded or otherwise labeled or differentiated such that the right fingers are ostensibly used to perform the right measurement tasks, in the right process, in the right shop. A problem arises when different shops use similar (but different) gauges or fingers with the same (or similar) color-coding, labeling, or differentiation, all of which can be placed in any holder or disc for any shop or process. For example, if Shop A or Process A uses red gauges or fingers with a min tolerance of 3.1 mm and a max tolerance of 5.5 mm, while Shop B or Process B uses red gauges or fingers with a min tolerance of 2 mm and a max tolerance of 4 mm, then there is a risk that the wrong red gauge or finger is inserted into a holder or disc for a given shop or process, if a red gauge or finger for Shop A or Process A is carried to or misplaced in Shop B or Process B, and process reliability is compromised.

It should be noted that this background is provided as illustrative context and environment only. It will be readily apparent to those of ordinary skill in the art that the principles of the present disclosure may be applied in other contexts and environments equally.

### BRIEF SUMMARY

Thus, the present disclosure provides a measurement tool with keyed gauges or fingers that mitigates this process reliability concern. A holder or disc is used for a task or tasks associated with a given shop or process that utilizes gauges or fingers that are keyed and also color-coded, labeled, or otherwise differentiated such that only the proper gauges or fingers among similar gauges or fingers can actually be received in that holder or disc for that shop or process. Accordingly, if a user has the correct holder or disc for a shop or process, only the proper gauges or fingers can be used. For each shop or process, measurement process instructions or steps can also be provided for each task associated with a holder or disc and the associated keyed gauges or fingers by color-coding, labeling, or differentiation correspondence.

Further, task logging can be performed by tracking holder or disc and keyed gauge or finger use via associated quick response (QR) codes, bar codes, or by sensing the engagement of various gauges or fingers in a given holder or disc while a process is carried out.

In one embodiment, the present disclosure provides a measurement tool, including: a holder defining a plurality of uniquely keyed slots, wherein each of the plurality of keyed slots has a different keying configuration; and a plurality of measurement fingers each including a uniquely keyed base adapted to be disposed in a corresponding one of the plurality of keyed slots. The holder includes a disc structure and the plurality of keyed slots are oriented radially about the disc structure. The plurality of keyed slots are open from a top surface or a bottom surface of the disc structure for insertion of a corresponding one of the plurality of measurement fingers. The keyed base of each of the plurality of measurement fingers includes one or more protrusions and each of the plurality of keyed slots includes one or more corresponding recesses, with the one or more protrusions corresponding to the one or more recesses for a matching keyed slot-measurement finger pair. The one or more protrusions include one or two protrusions disposed on a top, bottom, and/or side surface of the keyed base of each of the plurality of measurement fingers and the one or more recesses include a corresponding one or two recesses disposed on a top, bottom, and/or side surface of the corresponding keyed slots. Alternatively, the keyed base of each of the plurality of measurement fingers includes one or more recesses and each of the plurality of keyed slots includes one or more corresponding protrusions, with the one or more recesses corresponding to the one or more protrusions for a matching keyed slot-measurement finger pair. The one or more recesses include one or two recesses disposed on a top, bottom, and/or side surface of the keyed base of each of the plurality of measurement fingers and the one or more protrusions include a corresponding one or two protrusions disposed on a top, bottom, and/or side surface of the corresponding keyed slots. The disc structure is divided into a plurality of radial segments each corresponding to a measurement task and including a corresponding task label. Each of the plurality of radial segments corresponds to a pair of keyed slots and a pair of measurement fingers, with one of the pair of measurement fingers being a min measurement finger and another of the pair of measurement fingers being a max measurement finger. The min measurement finger includes a corresponding min or min dimension label and the max measurement finger includes a corresponding max or max dimension label. The holder includes a code adapted to allow the disc structure to be identified by a code scanner. Each of the plurality of measurement fingers also includes a code adapted to allow each of the plurality of measurement fingers to be identified by a code scanner. The measurement tool may also include a controller operable for confirming engagement of each of the plurality of measurement fingers in the corresponding keyed slot.

In another embodiment, the present disclosure provides a measurement method, including: providing a holder defining a plurality of uniquely keyed slots, wherein each of the plurality of keyed slots has a different keying configuration; and coupling a plurality of measurement fingers each including a uniquely keyed base adapted to be disposed in a corresponding one of the plurality of keyed slots to the holder. The holder includes a disc structure and the plurality of keyed slots are oriented radially about the disc structure. The keyed base of each of the plurality of measurement fingers includes one or more protrusions and each of the plurality of keyed slots includes one or more corresponding recesses, with the one or more protrusions corresponding to the one or more recesses for a matching keyed slot-measurement finger pair. The one or more protrusions include one or two protrusions disposed on a top, bottom, and/or side surface of the keyed base of each of the plurality of measurement fingers and the one or more recesses include a corresponding one or two recesses disposed on a top, bottom, and/or side surface of the corresponding keyed slots. Alternatively, the keyed base of each of the plurality of measurement fingers includes one or more recesses and each of the plurality of keyed slots includes one or more corresponding protrusions, with the one or more recesses corresponding to the one or more protrusions for a matching keyed slot-measurement finger pair. The one or more recesses include one or two recesses disposed on a top, bottom, and/or side surface of the keyed base of each of the plurality of measurement fingers and the one or more protrusions include a corresponding one or two protrusions disposed on a top, bottom, and/or side surface of the corresponding keyed slots. The measurement method may also include confirming engagement of each of the plurality of measurement fingers in the corresponding keyed slot using a controller.

In a further embodiment, the present disclosure provides a non-transitory computer-readable medium including instructions stored in a memory and executed by a processor to carry out the measurement steps including: given a holder defining a plurality of uniquely keyed slots, wherein each of the plurality of keyed slots has a different keying configuration, and a plurality of measurement fingers each including a uniquely keyed base adapted to be disposed in a corresponding one of the plurality of keyed slots, confirming engagement of each of the plurality of measurement fingers in the corresponding keyed slot using a controller.

In summary, the present disclosure provides a binary keying system for a GNG measurement tool. It will be readily apparent to those of ordinary skill in the art that aspects of each embodiment provided may be used with other embodiments, without limitation.

### BRIEF DESCRIPTION OF THE DRAWINGS

The present disclosure is illustrated and described with reference to the various drawings, in which like reference numbers are used to denote like system components/method steps, as appropriate, and in which:

FIG. 1 is a schematic diagram illustrating the use of the measurement tool of the present disclosure;

FIG. 2 is a top planar view of one embodiment of the disc of the measurement tool of the present disclosure;

FIG. 3 is a bottom planar view of one embodiment of the disc of the measurement tool of the present disclosure;

FIG. 4 is a bottom perspective view of one embodiment of the disc of the measurement tool of the present disclosure;

FIG. 5 is a side planar view of one embodiment of the disc of the measurement tool of the present disclosure;

FIG. 6 is a top perspective view of one embodiment of the fingers of the measurement tool of the present disclosure;

FIG. 7 is a top perspective view of another embodiment of the fingers of the measurement tool of the present disclosure;

FIG. 8 is a partial top planar view of one embodiment of the disc of the measurement tool of the present disclosure;

FIG. 9 is a partial bottom planar view of one embodiment of the measurement tool of the present disclosure;

FIG. 10 is a bottom planar view of one embodiment of the disc of the measurement tool of the present disclosure including a finger detection system;

FIG. 11 is a network diagram of a cloud-based system for implementing the various algorithms and services of the present disclosure;

FIG. 12 is a block diagram of a server that may be used in the cloud-based system of FIG. 11 or stand-alone; and

FIG. 13 is a block diagram of a user device that may be used in the cloud-based system of FIG. 11 or stand-alone.

### DETAILED DESCRIPTION

Again, the present disclosure provides a measurement tool with keyed gauges or fingers that mitigates process reliability concerns. A holder or disc is used for a task or tasks associated with a given shop or process that utilizes gauges or fingers that are keyed and also color-coded, labeled, or otherwise differentiated such that only the proper gauges or fingers among similar gauges or fingers can actually be received in that holder or disc for that shop or process. Accordingly, if a user has the correct holder or disc for a shop or process, only the proper gauges or fingers can be used. For each shop or process, measurement process instructions or steps can also be provided for each task associated with a holder or disc and the associated keyed gauges or fingers by color-coding, labeling, or differentiation correspondence.

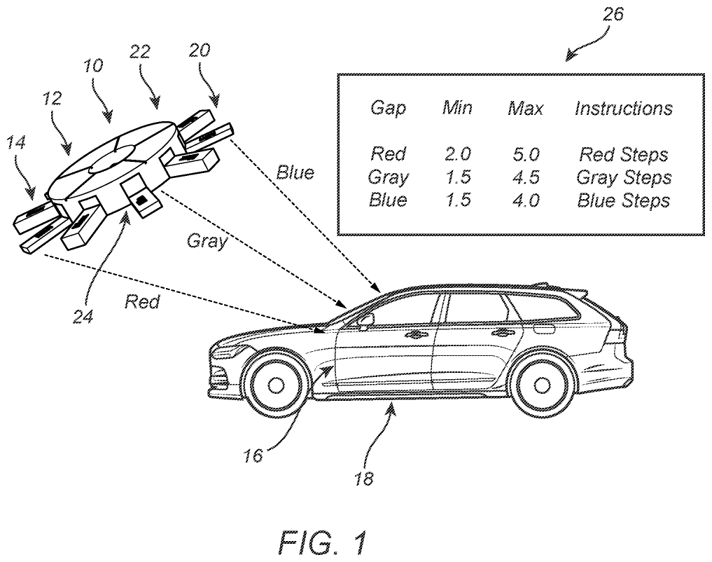

FIG. 1 is a schematic diagram illustrating the use of the measurement tool 10 of the present disclosure. The measurement tool 10 includes a holder 12 and a plurality of fingers 14 that extend outwards from the holder. The thickness, width, or length of each of these fingers 14 corresponds to a corresponding span or depth of an associated seam or gap 16 of the structure to be measured, such as a vehicle 18. The measurement tool 10 may be a GNG tool, such that pairs to fingers 14 are provided for each seam or gap 16, one representing a min dimension and one representing a max dimension. In this manner, a seam or gap 16 is acceptable if no wider than the max finger 14 and no narrower than the min finger 14. The measurement tool 10 may be used for a process including a series of tasks and thus may include multiple pairs of fingers 14, with each min-max pair of fingers 14 being applicable to a given seam or gap 16 to be measured. The pairs of fingers 14 may be labeled “min” or “max” 20 (or labeled with measurements or otherwise), and may be color-coded, labeled by task identifier, or otherwise differentiated by task. Correspondingly, various portions of the holder 12 may be labeled by task 22 and/or with measurements 24, indicating where the associated fingers 14 are placed. In proximity to the measurement tool 10, color-coded, task labeled, or otherwise differentiated instructions 26 corresponding to the pairs of fingers 14 and how associated measurements are to be performed are provided. These instructions 26 may be printed or displayed on a graphical user interface (GUI), for example,

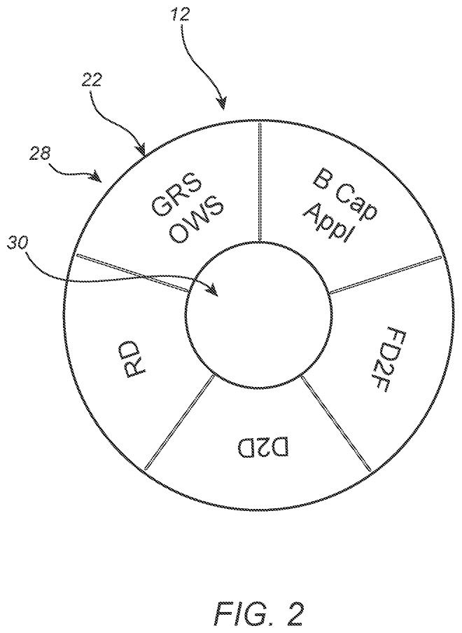

FIG. 2 is a top planar view of one embodiment of the holder 12 of the measurement tool 10 of the present disclosure. As illustrated, the holder 12 is a disc structure 28 having a substantially circular shape with a hole 30 in the middle or another attachment point for a retention strap, chain, or the like. The holder 12 may also be a rectangular structure or have any other suitable shape. Advantageously, given the disc structure 28, the task labels 22 may be disposed circumferentially around the visible top surface of the disc structure 28. As illustrated, the disc structure 28 includes 5 task labels 22 associated with a shop or process, each task label 22 being associated with a pair of corresponding min and max fingers 14, for a total of 10 measurements being provided by the measurement tool 10. It will be readily apparent to those of ordinary skill in the art that more or fewer task labels 22 and/or fingers 14 may be used.

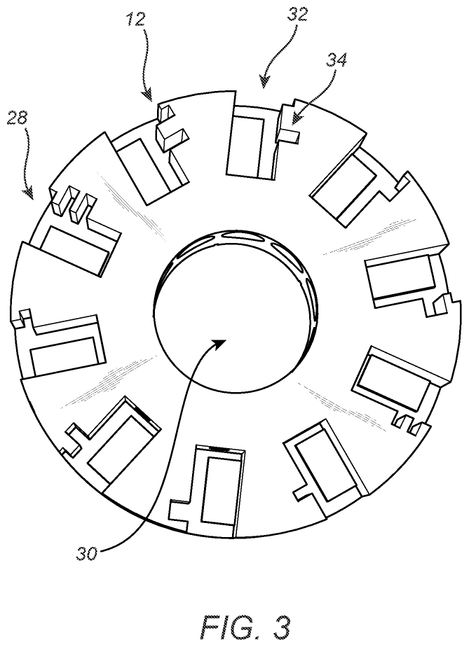

FIG. 3 is a bottom planar view of one embodiment of the holder 12 of the measurement tool 10 of the present disclosure. The bottom surface of the disc structure 28 defines a plurality of slots 32 associated with the various tasks into which the associated fingers 14 are received. As illustrated, the fingers 14 are inserted into the slots 32 from the bottom of the disc structure 28, however other arrangements could be utilized as well. Each of the slots 32 includes one or more keyed recesses 34 such that only a matching finger 14 can be inserted into each slot 32. As illustrated, each slot 32 includes 1 or 2 recesses 34 that are distributed along a side and/or bottom of the associated slot 32, with the spacing and arrangement of the recess(es) 34 for a given slot 32 providing the keying—1 or 2 protrusions on a matching finger 14 corresponding to the location(s) of the recess(es) of the appropriate slot 32 for the appropriate task. Given this arrangement, it is preferred that no fingers 14 be without protrusion(s) as such a finger could potentially be placed in any slot 32. For the same reason, simple slot/finger dimensional variations are also not preferred as smaller fingers 14 could be placed in larger slots 32 without resistance.

If 1 or 2 protrusions/recesses are used for 10 slots 32, in 5 slot pairs, around the disc structure 28, it is possible to have 65,536 permutations. In this sense, a binary key system is provided for a GNG tool. It should be noted that the roles of the recesses and the protrusions can be swapped with respect to the holder 12 and the fingers 14.

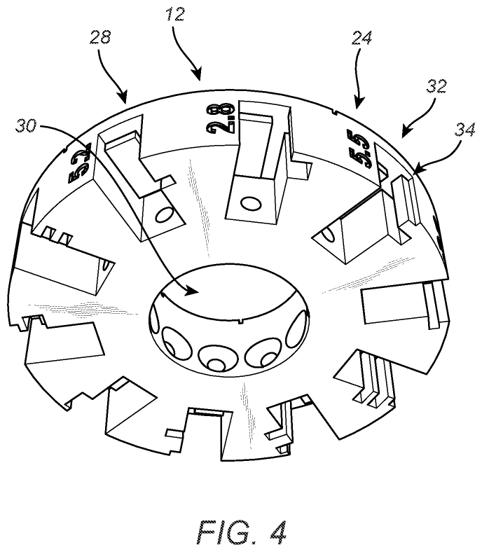

FIG. 4 is a bottom perspective view of one embodiment of the holder 12 of the measurement tool 10 of the present disclosure. The disc structure 28 is manufactured from a metallic material, a plastic material, or another durable material. As illustrated, measurements 24 corresponding to the various fingers 14 are disposed around the concentric outside surface of the disc structure 28. It should be noted that the disc structure 28 may be three-dimensional (3D) printed.

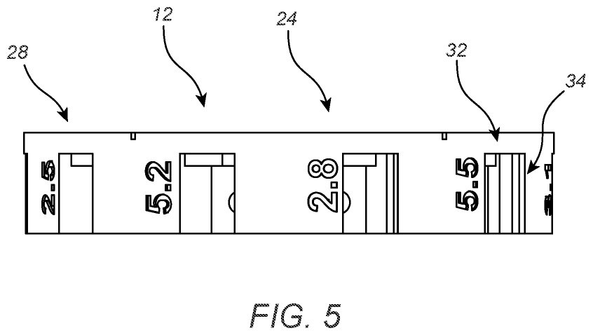

FIG. 5 is a side planar view of one embodiment of the holder 12 of the measurement tool 10 of the present disclosure. Again, the disc structure 28 is manufactured from a metallic material, a plastic material, or another durable material. As illustrated, measurements 24 corresponding to the various fingers 14 are disposed around the concentric outside surface of the disc structure 28.

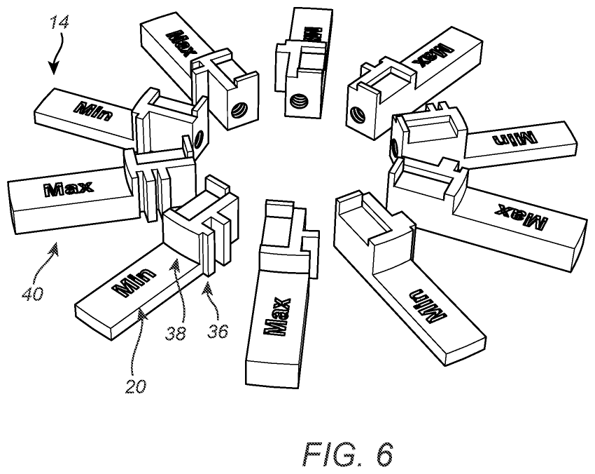

FIG. 6 is a top perspective view of one embodiment of the fingers 14 of the measurement tool 10 of the present disclosure. As illustrated, the fingers 14 include one or multiple protrusions 36 on the sides of the base 38 of each finger 14. The base 38 of each finger may have a substantially rectangular or prismatic shape. These protrusions 36 correspond to mating recesses 34 of the appropriate slot 32 of the disc structure 28. Thus, each finger 14 fits in only the proper slot 32 of the proper disc structure 28, ensuring that the proper finger 14 is used for each task associated with a shop or process. As illustrated, pairs of fingers 14 associated with a given task are color-coded and include min or max labels 20. The thickness, width, or length of the measurement portion 40 of each of the fingers 14 corresponds to the corresponding span or depth of the associated seam or gap 16 of the structure to be measured, such as the vehicle 18. The measurement tool 10 is thus a GNG tool, such that pairs to fingers 14 are provided for each seam or gap 16, one representing a min dimension and one representing a max dimension. In this manner, the seam or gap 16 is acceptable if no wider than the max finger 14 and no narrower than the min finger 14. Like the disc structure 28, the fingers 14 are manufactured from a metallic material, a plastic material, or another durable material. The fingers 14 may be 3D printed. FIG. 6 shows 10 min-max fingers 14 that may be coupled to and disposed around a disc structure 28 for a particular shop or process, including 5 different tasks, by way of example only.

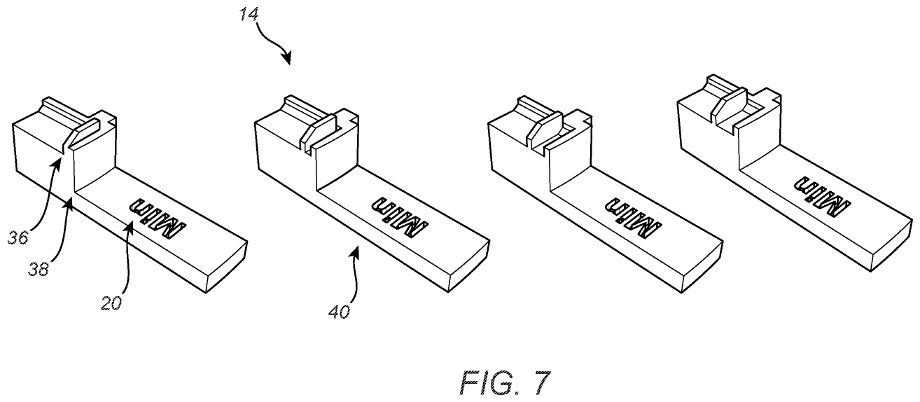

FIG. 7 is a top perspective view of another embodiment of the fingers 14 of the measurement tool 10 of the present disclosure. As illustrated, the fingers 14 include one or multiple protrusions 36 on the sides/top/bottom of the base 38 of each finger 14. Specifically, by way of example only, 1 protrusion 36 is provided on the top of the base 38 of each finger 14 and 1 protrusion 36 is provided on the side of the base 38 of each finger 14, providing keying in multiple dimensions. These protrusions 36 again correspond to mating recesses 34 of the appropriate slot 32 of the disc structure 28. Thus, each finger 14 fits in only the proper slot 32 of the proper disc structure 28, ensuring that the proper finger 14 is used for each task associated with a shop or process. Pairs of fingers 14 associated with a given task are color-coded or otherwise labeled or differentiated and include min or max labels 20. The thickness, width, or length of the measurement portion 40 of each of the fingers 14 corresponds to the corresponding span or depth of the associated seam or gap 16 of the structure to be measured, such as the vehicle 18. The measurement tool 10 is again a GNG tool, such that pairs to fingers 14 are provided for each seam or gap 16, one representing a min dimension and one representing a max dimension. In this manner, the seam or gap 16 is acceptable if no wider than the max finger 14 and no narrower than the min finger 14. Like the disc structure 28, the fingers 14 are manufactured from a metallic material, a plastic material, or another durable material. The fingers 14 may be 3D printed.

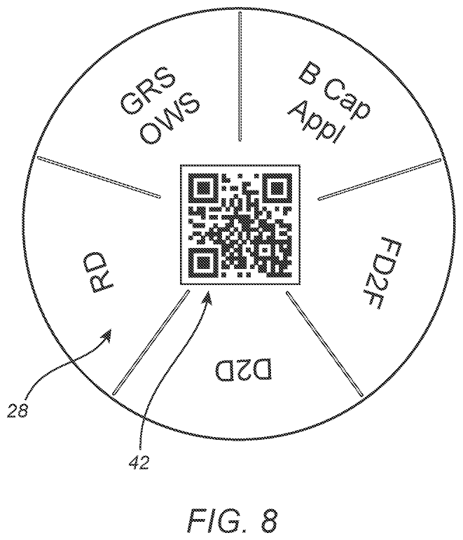

FIG. 8 is a partial top planar view of one embodiment of the disc structure 28 of the measurement tool 10 of the present disclosure. The disc structure 28 includes a QR code 42 for scanning and identifying the disc structure 28 in a specific shop or process.

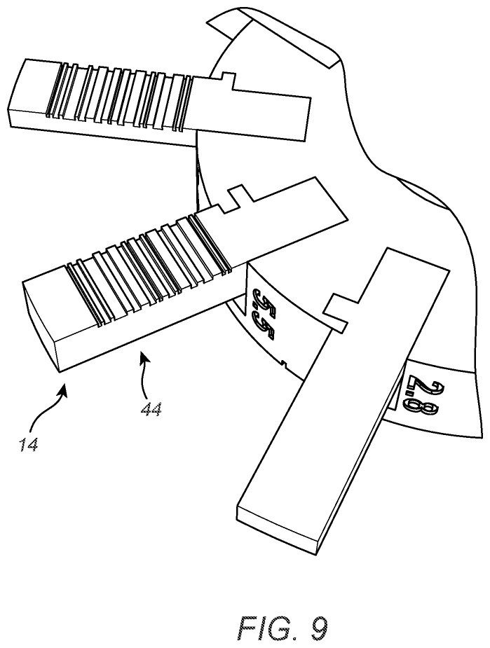

FIG. 9 is a partial bottom planar view of one embodiment of the measurement tool 10 of the present disclosure. The fingers 14 include a barcode strip 44 for scanning and identifying the fingers 14 in a specific shop or process.

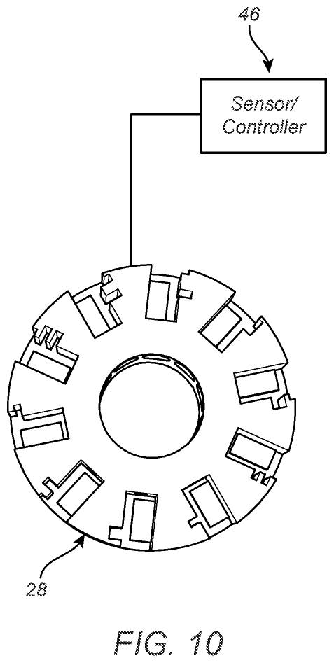

FIG. 10 is a bottom planar view of one embodiment of the disc structure 28 of the measurement tool 10 of the present disclosure including a finger detection system. The finger detection system includes a programmable logic controller (PLC) coupled to a sensor 46 or otherwise configured to detect engagement and use of the disc structure 28 and appropriate fingers 14 for the completion of a series of tasks associated with a process or shop.

Thus, in addition to using the techniques of the present disclosure for error proofing measurement fingers, these techniques can also be used in other instances where a communication to a PLC can define what tool is being used. For example, Car Type A comes into a cell. At the station, the operator has many different tools to choose from that are used on many car types. Using the key system of the present disclosure, the operator can communicate to the PLC which tool is being used by having the key system press down buttons (or release buttons if the tool is picked up) which then sends a byte output to the PLC which then confirms that the correct tool is being used. With this key system, one can error proof many different scenarios and know if the right tool is being used in a shop or process.

Further error proofing involves using the QR code on the gauge body (i.e., the GNG disc) and the barcode strip on the fingers for easy identification. The QR code could be designed so that internally it opens up instructions on how to use the gauge and also have part numbers that are compatible with the gauge. The barcode strips on the fingers can be used to easily identify each finger. These measures add increased confidence to the system.

Another use case could be in a production environment where it is more cost effective to have the product have a design so that a system can identify what product is there. Radio-frequency identification (RFID) tags add cost and complexity, but if the product itself can communicate what it is by using the binary system of the present disclosure, then one can identify different parts/assemblies by having them inserted into an assembly station. The binary key system then communicates what it is and there will be no miscommunication throughout all the steps of the assembly line even if there is significant manual intervention.

As an example, if an assembly line has 10 different solid metal cast parts, each part requires different assembly processes, but each part is very similar. The identification of the cast part can be found using the binary key system of the present disclosure. In the actual casting mold, one can have the byte in the mold so that each mold creates a unique byte specific to each type of cast part. When the cast part is placed in an assembly line, the byte presses down on buttons that identify what part is in the assembly line. This then tells the PLC that Part A is in the line and that the PLC needs to allow the use of all tools that are used with Part A. If a tool for Part B is used, the PLC knows there could be an issue and stops the line. Another method that could be used to identify the different castings is a laser engraver, but this could create a step in the process where manual intervention could allow a cast part to get the wrong engraving.

This also creates a system where in precision processes or processes that require very specific tool sets and verification of tools is used one can identify what tools were used without having to buy specialty tools. The binary key system of the present disclosure is installed on tools and each step that requires tools also requires the binary key system to be pressed into a receiver. This logs the tool being used automatically and, more importantly, the order the tools were used. This can keep quality checks automated and create a log order in which tools are used.

As another example, on an aircraft there can be specific steps for torquing bolts. They all get a pre-torque (50 in/lbs) and then all get a final torque (75 in/lbs). All torque wrenches which are set to 50 in/lbs receive the same binary key so they can be identified in a central system. When the tool is used on the aircraft, the binary key is pressed into a log machine. This identifies the tool being used. When the tool is done being used, it is pressed back into the log machine, which then can create a time stamp on how long the tool was used and if it was used before the 75 in/lbs tool. This can be used in lieu of a barcode because barcodes get scratched and are unreadable, but a binary key could be made of metal which is also water resistant and can be used around harsh chemicals without the need to replace. Taking this example one step further, where the use of barcode scanning is already established, in underwater or environments where it is difficult or impossible to use laser scanning (i.e., barcodes), this system is more robust in identifying what is used and in what order.

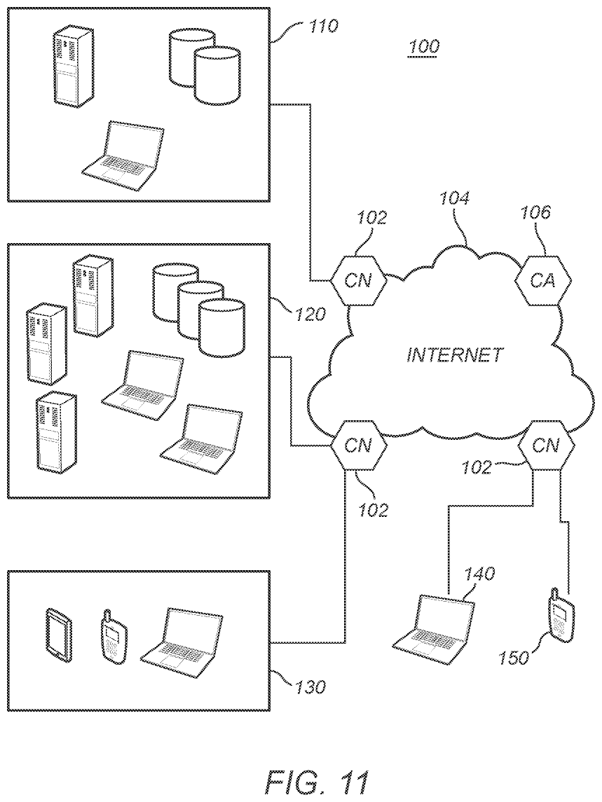

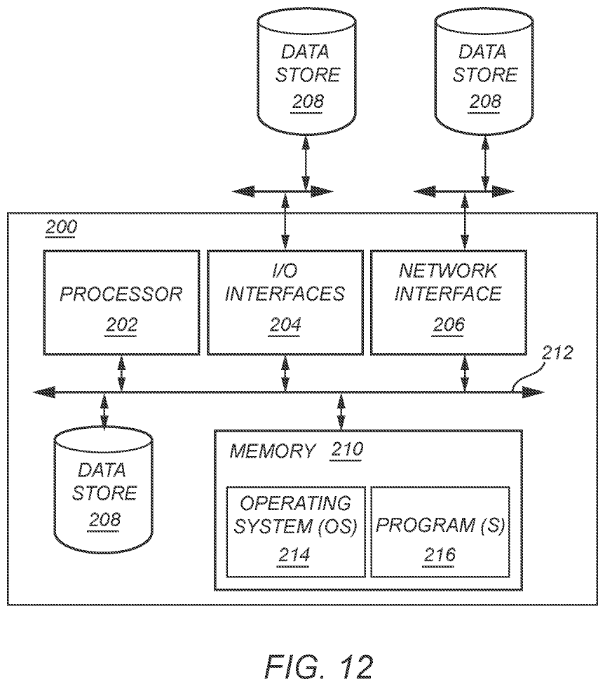

FIG. 11 is a network diagram of a cloud-based system 100 for implementing various cloud-based services of the present disclosure. The cloud-based system 100 includes one or more cloud nodes (CNs) 102 communicatively coupled to the Internet 104 or the like. The cloud nodes 102 may be implemented as a server 200 (as illustrated in FIG. 12) or the like and can be geographically diverse from one another, such as located at various data centers around the country or globe. Further, the cloud-based system 100 can include one or more central authority (CA) nodes 106, which similarly can be implemented as the server 200 and be connected to the CNs 102. For illustration purposes, the cloud-based system 100 can connect to a regional office 110, headquarters 120, various employee's homes 130, laptops/desktops 140, and mobile devices 150, each of which can be communicatively coupled to one of the CNs 102. These locations 110, 120, and 130, and devices 140 and 150 are shown for illustrative purposes, and those skilled in the art will recognize there are various access scenarios to the cloud-based system 100, all of which are contemplated here. The devices 140 and 150 can be so-called road warriors, i.e., users off-site, on-the-road, etc. The cloud-based system 100 can be a private cloud, a public cloud, a combination of a private cloud and a public cloud (hybrid cloud), or the like.

Again, the cloud-based system 100 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 110, 120, and 130 and devices 140 and 150. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 100 is illustrated here as one example embodiment of a cloud-based system, and those of ordinary skill in the art will recognize the systems and methods described here are not necessarily limited thereby.

FIG. 12 is a block diagram of a server 200, which may be used in the cloud-based system 100 (FIG. 11), in other systems, or stand-alone. For example, the CNs 102 (FIG. 11) and the central authority nodes 106 (FIG. 11) may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 11 depicts the server 200 in an oversimplified manner, and a practical embodiment may include additional components and suitably configured processing logic to support known or conventional operating features that are not described in detail here. The components (202, 204, 206, 208, and 210) are communicatively coupled via a local interface 212. The local interface 212 may be, for example, but is not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104 (FIG. 11). The network interface 206 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., a SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described here.

It will be appreciated that some embodiments described here may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described here. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described here, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described here for the various embodiments.

Moreover, some embodiments may include a non-transitory computer-readable medium having computer-readable code stored thereon for programming a computer, server, appliance, device, processor, circuit, etc. each of which may include a processor to perform functions as described and claimed here. Examples of such computer-readable mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described here for the various embodiments.

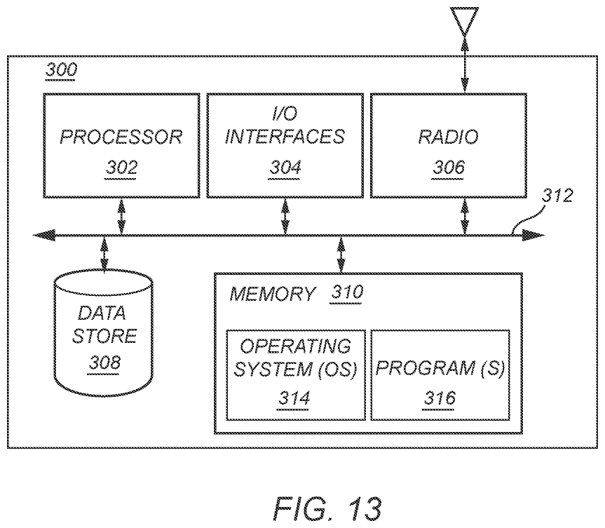

FIG. 13 is a block diagram of a user device 300, which may be used in the cloud-based system 100 (FIG. 11), as part of a network, or stand-alone. Again, the user device 300 can be a smartphone, a tablet, a smartwatch, an Internet of Things (IOT) device, a laptop, a virtual reality (VR) headset, etc. The user device 300 can be a digital device that, in terms of hardware architecture, generally includes a processor 302, I/O interfaces 304, a radio 306, a data store 308, and memory 310. It should be appreciated by those of ordinary skill in the art that FIG. 12 depicts the user device 300 in an oversimplified manner, and a practical embodiment may include additional components and suitably configured processing logic to support known or conventional operating features that are not described in detail here. The components (302, 304, 306, 308, and 310) are communicatively coupled via a local interface 312. The local interface 312 can be, for example, but is not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 306 enables wireless communication to an external access device or network. Any number of suitable wireless data communication protocols, techniques, or methodologies can be supported by the radio 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

Again, the memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 13, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network, such as the cloud-based system 100 (FIG. 11).

Thus, again, the present disclosure provides a measurement tool with keyed gauges or fingers that mitigates process reliability concerns. A holder or disc is used for a task or tasks associated with a given shop or process that utilizes gauges or fingers that are keyed and also color-coded, labeled, or otherwise differentiated such that only the proper gauges or fingers among similar gauges or fingers can actually be received in that holder or disc for that shop or process. Accordingly, if a user has the correct holder or disc for a shop or process, only the proper gauges or fingers can be used. For each shop or process, measurement process instructions or steps can also be provided for each task associated with a holder or disc and the associated keyed gauges or fingers by color-coding, labeling, or differentiation correspondence.

Although the present disclosure is illustrated and described with reference to illustrative embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A measurement tool, comprising:
a holder defining a plurality of uniquely keyed slots, wherein each of the plurality of keyed slots has a different keying configuration; and
a plurality of measurement fingers each comprising a uniquely keyed base adapted to be disposed in a corresponding one of the plurality of keyed slots.

2. The measurement tool of claim 1, wherein the holder comprises a disc structure and the plurality of keyed slots are oriented radially about the disc structure.

3. The measurement tool of claim 2, wherein the plurality of keyed slots are open from a top surface or a bottom surface of the disc structure for insertion of a corresponding one of the plurality of measurement fingers.

4. The measurement tool of claim 1, wherein the keyed base of each of the plurality of measurement fingers comprises one or more protrusions and each of the plurality of keyed slots comprises one or more corresponding recesses, with the one or more protrusions corresponding to the one or more recesses for a matching keyed slot-measurement finger pair.

5. The measurement tool of claim 4, wherein the one or more protrusions comprise one or two protrusions disposed on a top, bottom, and/or side surface of the keyed base of each of the plurality of measurement fingers and the one or more recesses comprise a corresponding one or two recesses disposed on a top, bottom, and/or side surface of the corresponding keyed slots.

6. The measurement tool of claim 1, wherein the keyed base of each of the plurality of measurement fingers comprises one or more recesses and each of the plurality of keyed slots comprises one or more corresponding protrusions, with the one or more recesses corresponding to the one or more protrusions for a matching keyed slot-measurement finger pair.

7. The measurement tool of claim 6, wherein the one or more recesses comprise one or two recesses disposed on a top, bottom, and/or side surface of the keyed base of each of the plurality of measurement fingers and the one or more protrusions comprise a corresponding one or two protrusions disposed on a top, bottom, and/or side surface of the corresponding keyed slots.

8. The measurement tool of claim 2, wherein the disc structure is divided into a plurality of radial segments each corresponding to a measurement task and comprising a corresponding task label.

9. The measurement tool of claim 8, wherein each of the plurality of radial segments corresponds to a pair of keyed slots and a pair of measurement fingers, with one of the pair of measurement fingers being a min measurement finger and another of the pair of measurement fingers being a max measurement finger.

10. The measurement tool of claim 9, wherein the min measurement finger comprises a corresponding min or min dimension label and the max measurement finger comprises a corresponding max or max dimension label.

11. The measurement tool of claim 1, wherein the holder comprises a QR code adapted to allow the disc structure to be identified by a QR code scanner.

12. The measurement tool of claim 1, wherein each of the plurality of measurement fingers comprises a barcode adapted to allow each of the plurality of measurement fingers to be identified by a barcode scanner.

13. The measurement tool of claim 1, further comprising a controller operable for confirming engagement of each of the plurality of measurement fingers in the corresponding keyed slot.

14. A measurement method, comprising:
providing a holder defining a plurality of uniquely keyed slots, wherein each of the plurality of keyed slots has a different keying configuration; and
coupling a plurality of measurement fingers each comprising a uniquely keyed base adapted to be disposed in a corresponding one of the plurality of keyed slots to the holder.

15. The measurement method of claim 14, wherein the holder comprises a disc structure and the plurality of keyed slots are oriented radially about the disc structure.

16. The measurement method of claim 14, wherein the keyed base of each of the plurality of measurement fingers comprises one or more protrusions and each of the plurality of keyed slots comprises one or more corresponding recesses, with the one or more protrusions corresponding to the one or more recesses for a matching keyed slot-measurement finger pair.

17. The measurement method of claim 16, wherein the one or more protrusions comprise one or two protrusions disposed on a top, bottom, and/or side surface of the keyed base of each of the plurality of measurement fingers and the one or more recesses comprise a corresponding one or two recesses disposed on a top, bottom, and/or side surface of the corresponding keyed slots.

18. The measurement method of claim 14, wherein the keyed base of each of the plurality of measurement fingers comprises one or more recesses and each of the plurality of keyed slots comprises one or more corresponding protrusions, with the one or more recesses corresponding to the one or more protrusions for a matching keyed slot-measurement finger pair.

19. The measurement method of claim 18, wherein the one or more recesses comprise one or two recesses disposed on a top, bottom, and/or side surface of the keyed base of each of the plurality of measurement fingers and the one or more protrusions comprise a corresponding one or two protrusions disposed on a top, bottom, and/or side surface of the corresponding keyed slots.

20. The measurement method of claim 14, further comprising confirming engagement of each of the plurality of measurement fingers in the corresponding keyed slot using a controller.

21. A non-transitory computer-readable medium comprising instructions stored in a memory and executed by a processor to carry out the measurement steps comprising:
given a holder defining a plurality of uniquely keyed slots, wherein each of the plurality of keyed slots has a different keying configuration, and a plurality of measurement fingers each comprising a uniquely keyed base adapted to be disposed in a corresponding one of the plurality of keyed slots, confirming engagement of each of the plurality of measurement fingers in the corresponding keyed slot using a controller.
